(19) United States
(12) Patent Application Publication
(10) Pub. No.: US 2024/0202641 A1
(43) Pub. Date: Jun. 20, 2024

(54) System and Method for Preventing Human Errors

(71) Applicant: Lizandra Bernier-Rivera, Guayama, PR (US)

(72) Inventor: Lizandra Bernier-Rivera, Guayama, PR (US)

(21) Appl. No.: 18/392,881

(22) Filed: Dec. 21, 2023

Related U.S. Application Data
(60) Provisional application No. 63/434,415, filed on Dec. 21, 2022.

(51) Int. Cl. G06Q 10/0639

(52) U.S. Cl. CPC G06Q 10/06395

(57) ABSTRACT

A system and method with predefined organizational factors that transforms a basic computer system into a specialized system with the capability to visualize potential human errors by people to optimize their work results. The method includes a continuous evaluation of the predefined organizational factors from a group of people involved in the process. The evaluation is documented in the specialized system, where it includes the identification of organizational factors that are under control and those that need to be mitigated as potential causal factors of human errors. The specialized system includes a continuous process workflow that allows the user to identify, visualize, analyze, and correct those potential causal factors of human errors by implementing corrective actions to mitigate potential undesired results. Moreover, the specialized system includes additional functionalities to visualize risks by providing key performance indicators, including a management overview of the operation.

### RELATED APPLICATIONS

This application claims priority from U.S. Provisional Application 63/434,415, filed on Dec. 21, 2022.

### BACKGROUND

Every day, people face different challenges that can hinder their efforts in accomplishing their tasks, which may result in mistakes.

For example, in the manufacturing industry, multiple products are produced and released daily. To achieve that, people interact with hundreds of organizational factors such as management decisions, standard operating procedures, equipment, instructions, materials, etc., in all the operational areas. But it is more complex when we consider how the constant changes (i.e., organization management changes, new technologies, new operating procedures, new work environment, etc.) also change the interaction of people with the organizational factors required and/or expected to complete their job at the end of the day. Just to achieve one task aimed to achieve result, an employee can interact with multiple operational procedures (e.g. ten standard operating procedures), multiple equipment and tools, management decisions, and other organizational factors. Moreover, the people's interactions increase with the number of employees through the organization. Too many interactions with organizational factors coupled with multiple daily changes provoke complex scenarios for people to manage their daily work routine. It applies to all operational areas from the receiving, warehouse storage, quality controls, manufacturing, packaging, shipping, etc., where we can find a lot of people interacting with a lot of organizational factors be made vulnerable to negative organizational factors commonly known, but not identified and mitigated until a process deviation occurs. It is common in the industry to be reactive instead of proactive, by implementing a corrective action once a deviation in process occurs.

For example, U.S. Pat. No. 10,948,887 is directed towards a system and/or control apparatus that processes data inputs to provide outputs. With a software product, it implements a method that using state variables generates addressable solutions to meet requirements. However, the '887, patent doesn't include organizational factors through the different production areas to visualize potential risks. Moreover, it concentrates on using data inputs to determine outputs and potential variations.

Similarly, U.S. Pat. No. 10,862,902 is directed towards a system and method that provides automated security analysis and network intrusion protection in an industrial environment.

This system considers a Security Analysis Methodology (SAM) that provides an automated process that generates a set of security guidelines for the industry to use. However, it does not consider organizational, and regulatory factors that can visualize risks and proactively produce corrective actions prior to deviations as provided herein.

A structured and continuous process is required to take control of all organizational factors that need people to optimize their work performance every day. With that in mind, the Human Optimal Work Execution Management (HOWEM) application and method was created. It is a proactive system designed to visualize potential risks to produce corrective actions aimed at preventing human errors by identifying and correcting the organizational factors that have a high potential to affect people's work performance. HOWEM is designed to correct potential causal factors of human errors, not to correct people's behavior.

### BRIEF DESCRIPTION OF THE SEVERAL VIEWS OF THE DRAWINGS

To easily identify the HOWEM system and method and promote the use of its computerized system, the following figures were developed to explain how the system communicates and advances:

FIG. 1 illustrates the process that activates in the computerized system when a failure event occurs,

FIG. 2 illustrates HOWEM Methodology and the different steps a task can travel if it represents a negative or a positive factor,

FIG. 3 illustrates a routine to conduct the HOWEM audit execution process,

FIG. 4 illustrates a sites database at its back end and what the user would see through its front end,

FIG. 5 illustrates the structure of the methods casual factors including its position and group compilation,

FIG. 6 illustrates an exemplary baseline list of casual factors included in the computerized system used in the audit process,

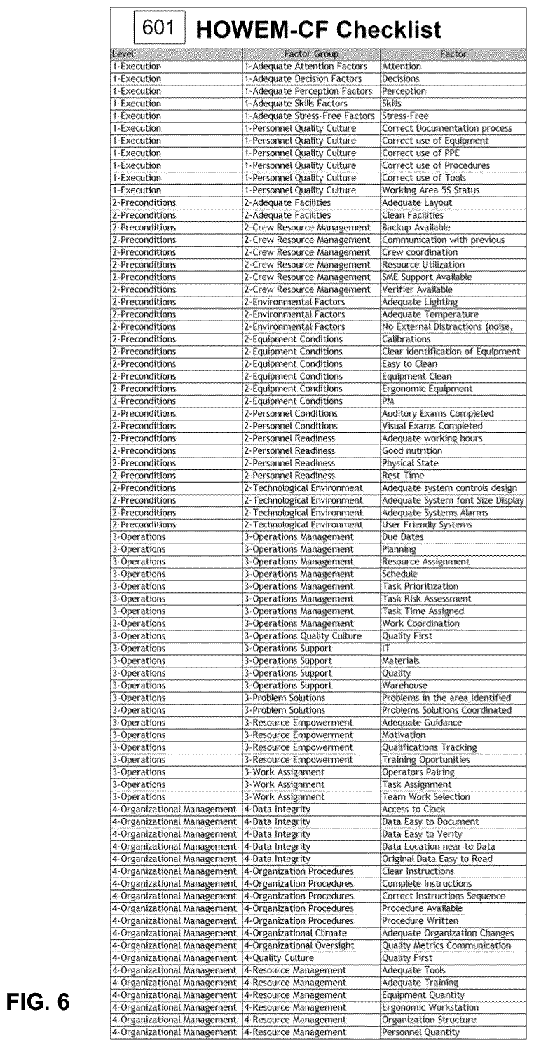

FIG. 7 illustrates the HOWEM process through which the auditor conducts the audit process,

FIG. 8 illustrates the key elements of the system and method,

FIG. 9 illustrates the key principles which comprise the system and method,

FIG. 10 illustrates the computerized page which comprised the audit record to be filled and generated using the system and method,

FIG. 11 illustrates the computerized page which comprises the audit execution by the auditor,

FIG. 12 illustrates the list of Active Human Error Factors (AHEF) included on the quality evaluation of the auditor in the computerized system,

FIG. 13 illustrates form “AHEF—HOWEM Brainstorming Board”

FIG. 14 illustrates an example of the corrective action the computerized system will generated if a process deviation occurs,

FIG. 15 illustrates a routine to obtain a unique page measuring the effectiveness of the corrective actions implemented as outlined in FIG. 14,

FIG. 16 illustrates a list of the general functionalities of the system and method in the computerized system.

### DETAILED DESCRIPTION OF THE INVENTION

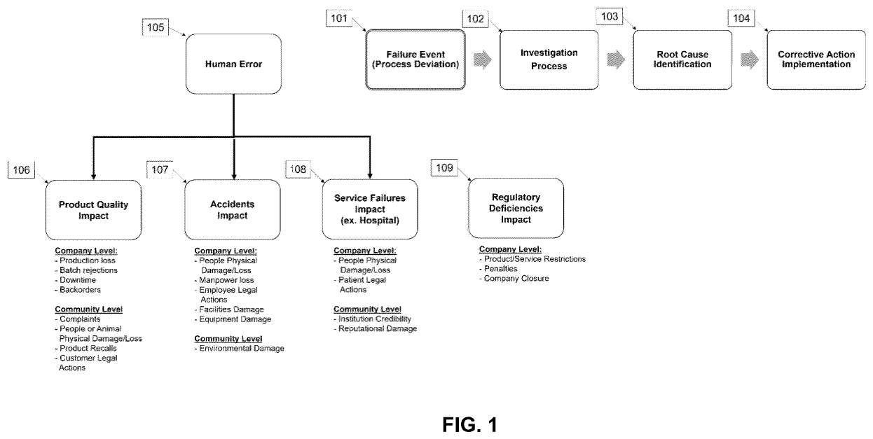

According to FIG. 1, when a failure event or process deviation happens 101, a comprehensive investigation 102 is carried out to identify the root cause 103 of the event. Once the root cause of the event is identified, corrective actions 104 are suggested and carried considering the visualized risks to try to avoid future potential risks. The method considers as a component that human errors 105 comprise most of the events that cause product quality issues 106, accidents 107, and service failures 108 in all types of industrial processes.

Instead of being reactive, the present invention through the system and method transforms a generic computer into a specialized one that allows to visualize failure risks in processes and be proactive to mitigate its potential future result. The objective is to identify the event's root cause before the event's occurrence, such as fixing a hole in the road before an accident occurs. When we consider complex industrial processes, product quality issues 106 can lead to significant expenses, including production loss, batch rejection, downtime, and backorders. At the community level, it has the potential to cause physical harm or death to both people and animals. Additionally, it can result in legal action and complaints from customers, while inciting in recalls of the product. Moreover, considering the impact of accidents 107, employees may suffer physical harm or loss, resulting in a loss of manpower and/or legal action. Furthermore, equipment and facilities may also be damaged. At the community level, environmental damage may occur, leading to harm to the community. On another note, service failures 108 can have serious consequences too. They can result in physical harm or even death to people or animals and can lead to legal actions by customers against the company. Furthermore, it is worth noting that many of the inadequacies identified by regulatory agencies 109, such as the failure to establish a proper process, neglecting to follow established procedures, and poor equipment design, are included in the process as they are attributable to human error.

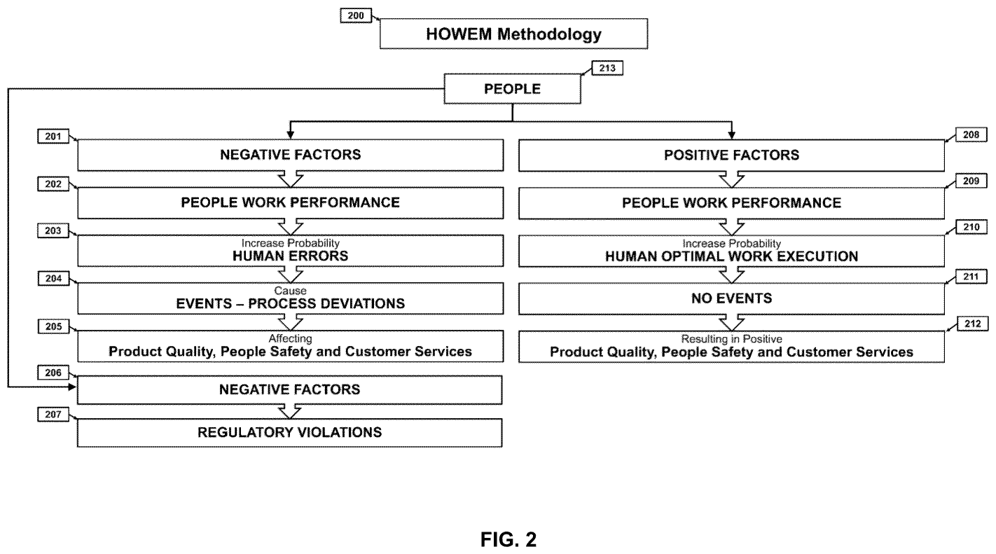

Referring to FIG. 2. The HOWEM Methodology 200 states that when negative organizational factors 201 affects people work performance 202, it increases the probability of Human Errors 203 causing events 204 that affect: Product Quality, People Safety and Customer Services 205, so these negative factors 201 are defined as root cause of human errors 203. Also, method 200 considers that negative organizational factors 206 also cause Regulatory violations 207. On the other side, if positive organizational factors 208, impact people work performance 209, it can increase the probability to optimize their work 210, forecasting the possibility to eliminating future events 211 and promoting the production of high-quality products and services including a safe working environment 212. The aforementioned factors explain and expand on the different elements that comprise the HOWEM method 210. If people 213 cause the negative organizational factors 201/206 that cause events 204 and regulatory violations 207, the negative organizational factors 201/206 are human errors too which can be visualized through the computerized system.

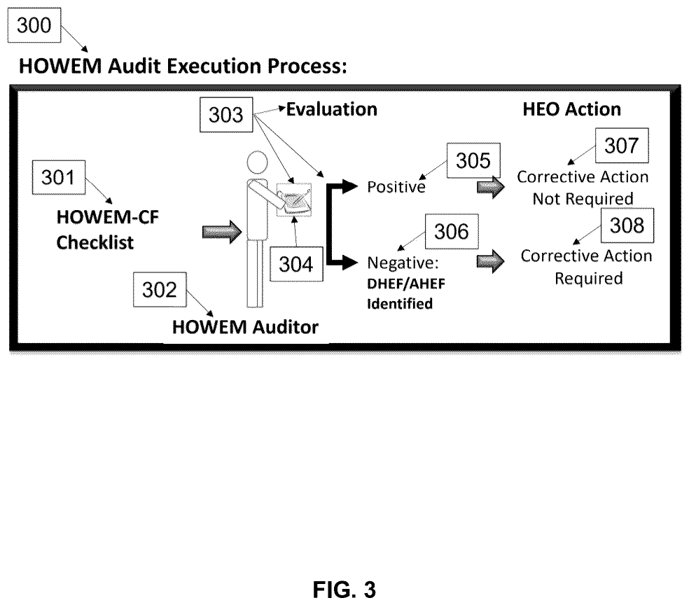

In FIG. 3., we can observe an example of the audit execution process of HOWEM. It starts with an audit process that considers the pre-defined HOWEM-CF Checklist 301, which includes a list of organizational factors required to optimize human work execution. In 302 the auditor or an expert employee of the area will conduct an evaluation 303 considering the positive 305 or negative 306 factors identified in the evaluation. If the organization factors promote an optimal work execution, it is evaluated as positive 305, and will not require a corrective action 307. On the other side, if the organization factors could produce a human error, it is evaluated as a negative factor 306, and will require corrective action 308. The auditor 302 will comprise of obtaining their peers feedback to complete the audit record documentation (i.e., brief deficiency description). The computerized system allows the identification of negative 306 organizational factors since the design phase of a new system named Design Human Error Factors (DHEF). If identified during the operational process execution, they comprise the Active Human Error Factors (AHEF).

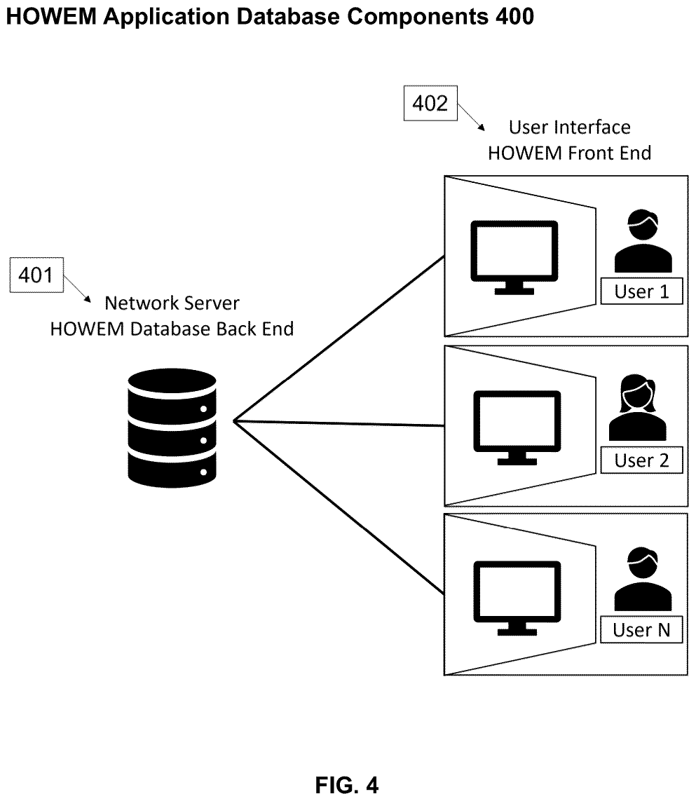

FIG. 4. shows the embodiment of the system and method database infrastructure. The system comprises a back end 401 and a front end 402 which will manage and show all the information stored in the computerized system. The back end 401 responsible for managing the data, business logic, and server-side processing, while the front end 402 portrays a user-friendly interface that facilitates interaction with the database.

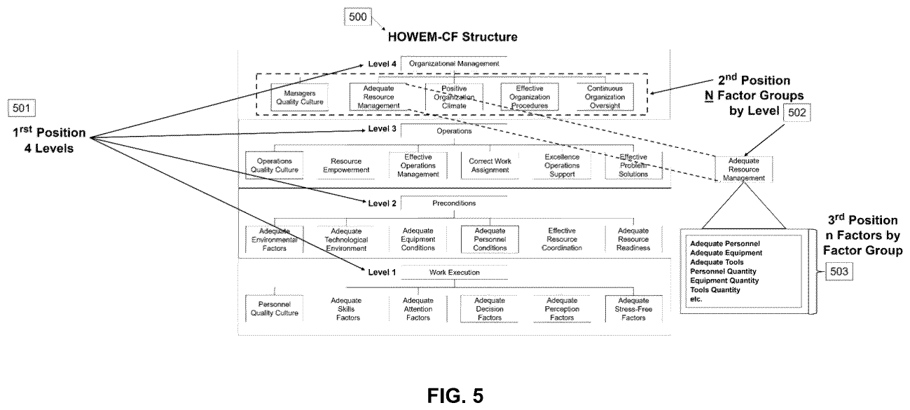

FIG. 5. shows the data system structure used to develop the pre-defined casual factors included in the HOWEM computer system. For example, the development of the method starts with the creation of the structure. The structure 500 was designed using as a model the HFACS (Human Factors Classification and Analysis System). (Douglas Wiegmann, Ph.D. from the University of Illinois, and Scott A. Shappell, Ph.D. from the Civil Aerospace Medical Institute for the US Navy).

The HOWEM-CF Structure 500 is organized in four levels 501:
Level 1: Execution—Refers to employee work execution performance
Level 2: Preconditions—Refers to work preconditions
Level 3: Operations—Refers to operational areas support
Level 4: Organizational Management—Refers to the organization management.

Considering the levels 501, each level can contain N (# number of) Factor Groups 502, each factor group can contain N (#Number of) factors 503. The structure is used to define a set of factors required to optimize people's work obtaining the HOWEM-CF Checklist 601. It is used during the audit routine process to control the factors that affect people's work performance. The set of factors, checklist 601 can be updated according to the costumer's requirements and industry requirements. In addition, the computerized system allows the functionality to add additional Factor Groups 502 and Factors 503. Once the HOWEM-CF Checklist 601 is complete, the HOWEM optimization process 700 can be initiated electronically.

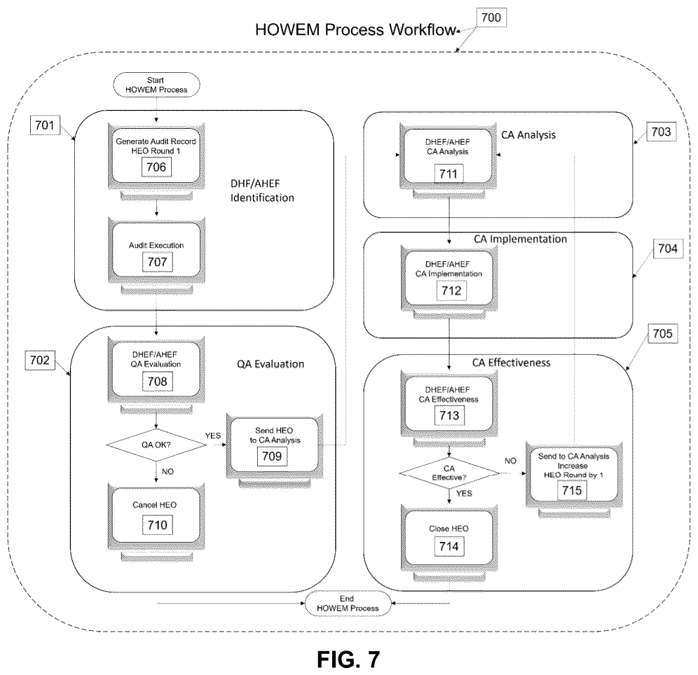

FIG. 7. shows and example of the continuous optimization process of the system and method. In block 701, routine 700 stored the identified DHEF/AHEF factors which are comprised of: Audit Record Generation 704, Audit Execution 705 and Audit Evaluation 706. In block 707, determines if QA (or any other unit e.g. safety) evaluate the negative observation to ensure that no failure events/deviations are documented in the system,. If the observation is correct, it will send it to corrective action analysis 708 and if not, it will cancel the evaluation order 709. In block 710, block 708 determines the analysis process it will from the computerized system and method by using electronic brainstorming boards to analyze possible corrective actions while leveraging employees' recommendations. Following block 710, next step will include the implementation of corrective actions 711 while it measured the effectiveness of the corrective actions 712 to determine the success of its implementation to validate if the evaluation order can be closed 714 or if required an increase in the analysis of potential corrective actions 715.

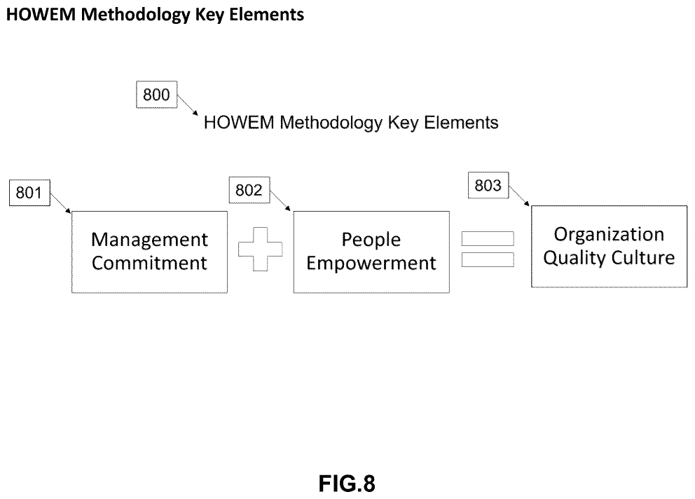

In FIG. 8. we can observe depicted the key elements which comprise the HOWEM system and method. HOWEM requires management commitment 801 that requires them to lead by example to demonstrate that they are leaders that put forwards actions. Sub-elements such as quality, security, and safety for the industry and organization serve as testament to that objective. In addition, block 802 comprises of people empowerment where employees recognize their people's experience, education, and skills as the most important asset of the organization. Even though the computerized system will provide them with the insight to visualize risk, at the end of the day they will determine the corrective actions to optimize their work execution. Both block 801 and 802, will result in an organization quality culture 803 that has instilled values aimed to prevent process deviations. Everyone is called upon to know, understand, and control the required factors to optimize people's work performance in all operational areas.

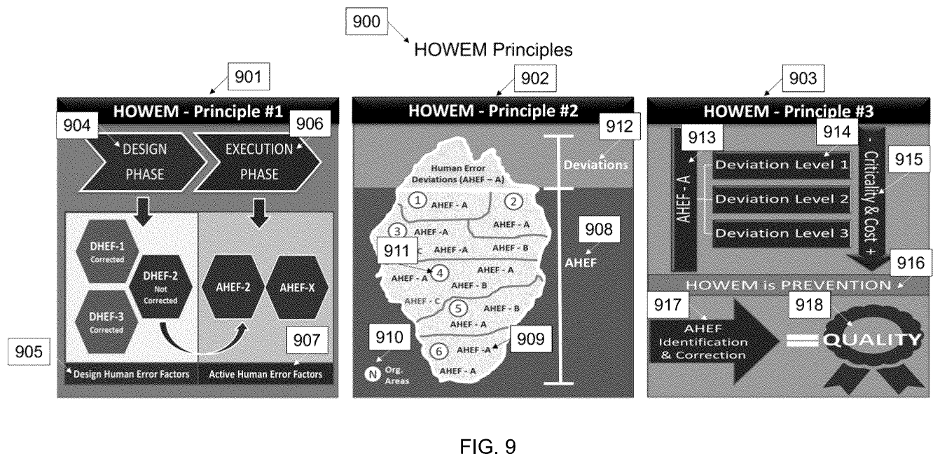

FIG. 9. Shows the three key principles that encompass the HOWEM system and method. The first principle, 901, starts during design phase 904 of a new computerized system or process. When a design human error factor (DHEF) 905 is not identified and corrected during the design phase 904, it will provoke an active human error factor (AHEF) 907 at the execution phase 906 once implemented. The system and method included herein seeks to preempt such potential results at the design phase. The second principle 902 considers when an active human error factor (AHEF) 908 909 is identified during the audit execution 705 process. The principle states that one AHEF 909 represents a negative cultural symptom of the organizational area where it was found 911 and how the same AHEFs impact the probability that there can be potential deviations in the process 912. For example, the same type of AHEF 908 909 impacting multiple areas 910 911 increase the probability of deviations related to that AHEF. The third principle 903 considers how the probability of a process deviation due to a human error decreases if proactive actions are taking prior to its happening. For example, non-clear instructions in a process 913 can cause a deviation at any time at different levels 914, increasing the criticality and cost 915 through the different deviation levels 914. In block 916, the identification and correction of AHEF 917 given by the computerized system will lead to its elimination by prevention and quality results are obtained 918.

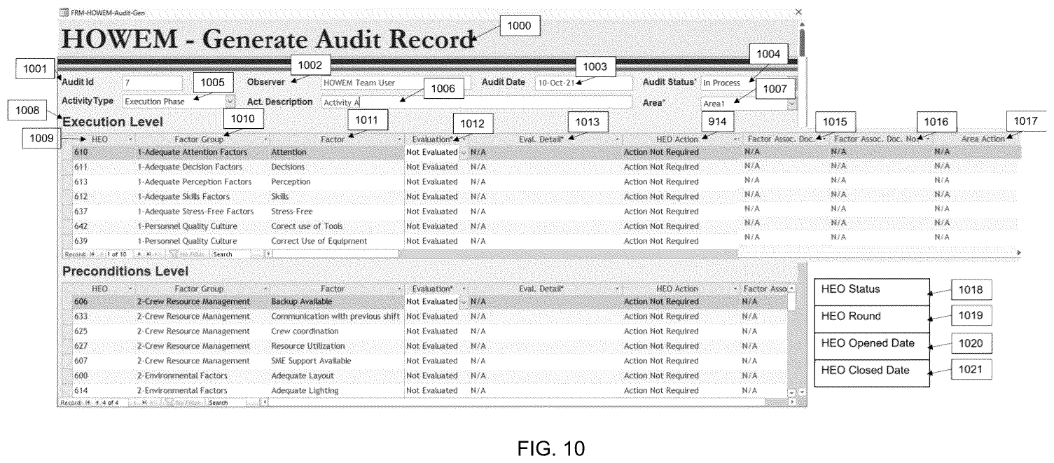

Referring to FIG. 10., in block 1000 it initiates the generation of the audit record in the computerized system. First, the auditor should complete the following header fields:
1. Activity Type 1005 field is used to specify the phase of the activity to be evaluated during the audit. The user should specify if the audit record is used to analyze the design phase of a new system or an implemented process system during the execution phase.
2. Activity Description 1006 field is used to describe the activity to be evaluated during the audit.
3. Area 1007 field is used to indicate where the audit process is performed.

Once the auditor completes the above fields, the computerized system updates automatically all the remain header fields:
1. Audit Id 1001 field is an automatic sequential number.
2. Observer 1002 field is populated by the system with the login username.
3. Audit Date 1003 field contains the audit current date.
4. Audit Status 1004 field is used to specify the status of the audit. The initial default status is In Process.

After the header section update, the computerized system uploads all the factors defined in the casual factor checklist 601 automatically to the Audit Record 1001.

The system assigns an automatic HEO 1009 (HOWEM Evaluation Order) for each Factor 1011. Each evaluation order 1009 generated by the computerized includes the following related fields to be updated by the auditor, the evaluation 1012 field is used to document the Factor conditions during the audit process. The evaluation field 1012 includes a pre-defined drop-down menu of approved system values (i.e., Positive, Negative, Not Evaluated (Default Value), Not Applicable). At the execution level, the evaluation detail 1013 provides a description of the factor conditions observed during the audit process which need to be filled out by the auditor. On another note, the HEO Action 1014 field allows the auditor to indicate the corrective action progress of the process until the corrective action is implemented effectively. It includes a pre-determined list of information to be filled in. (i.e., Action Not Required (Default Value), Corrective Action Required, Corrective Actions Analysis, Corrective Action Implemented, Corrective Action Effective, Corrective Action (Not HOWEM)). The Factor Assoc. Doc. 1015 (Factor Associated Document) field is used to specify the document type associated to the Factor (if any). The Factor Assoc. Doc. No. 1016 (Factor Associated Document Number) field is used to register the number of the Factor Assoc. Doc; the default value is “N/A”. The Area Action 1017 field is used by the auditor to document any immediate action taken to remediate the deficiency associated with the evaluation order during the audit process until a corrective action is implemented.

HEO Status 1018 field is updated by the system automatically once the HEO Action 1014 field is updated. The pre-determined field values are Open, Cancelled and Closed. In HEO Status 1018, routine 1000 ends.

However, the computerized systems provide additional visibilities such as the HEO Round 1019 field that indicates the number of times that a DHEF/AHEF factor is analyzed and corrected. The HEO Round increases by one once a HEO 1009 is sent back for additional analysis when the implemented corrective actions are not effective. The HEO Opened Date 1020 field is populated by the computerized system with the current date once the Evaluation field is updated/documented in the system during the audit process. The HEO Closed Date 1021 field indicates the HEO closure date, it is populated by the system with the current date once the HEO Action 1014 is documented as a corrective action.

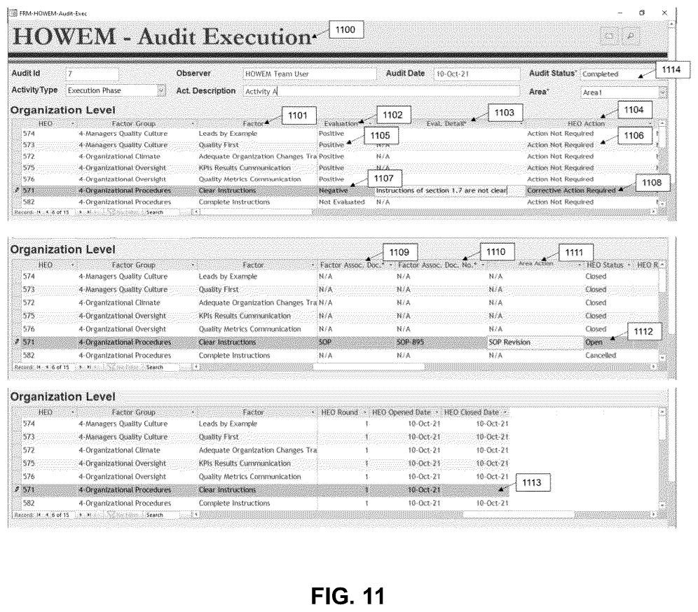

Referring to FIG. 11., Audit Execution process 1100 is used to identify the negative organizational factors 306 that are affecting people's work performance. It is also used to evaluate positive organizational factors 305 that promote optimal work execution. Once the HOWEM Audit Record Generation 1000 process is completed, the Audit Record 1001 is ready for the Audit Execution process 1100. The auditor should evaluate each Factor as positive 304 or negative 305 filling in the information in the Evaluation field 1102.

If factor 1101 is not evaluated or is not applicable to the evaluated activity, it should be updated accordingly. The computerized system updates HEO Action 1104 field automatically. For Positive 1105 evaluations the system updates the HEO Action 1104 to Action Not Required 1106. For Negative 1107 evaluations, the computerized system updates the HEO Action 1104 to Corrective Action Required 1108. When applicable, the auditor should update the Eval. Detail 1103, Factor Assoc. Doc. 1109, Factor Assoc. Doc. No. 1110 and Area Action 1111 fields considering the information obtained in the audit. For Negative Factors 1107, HEO Status 1112 will remain Open and HEO Closed Date 1113 will be populated once the negative factor 1107 is corrected. Once finished, the evaluation of all applicable factors 1101, the auditor should change Audit Status 1114 to Completed. An Audit report containing the negative factors 1107 identified during the Audit Execution process 1100 can be shared via e-mail in PDF format by clicking the Envelope icon. After clicking the envelope icon, the routine 1100 ends.

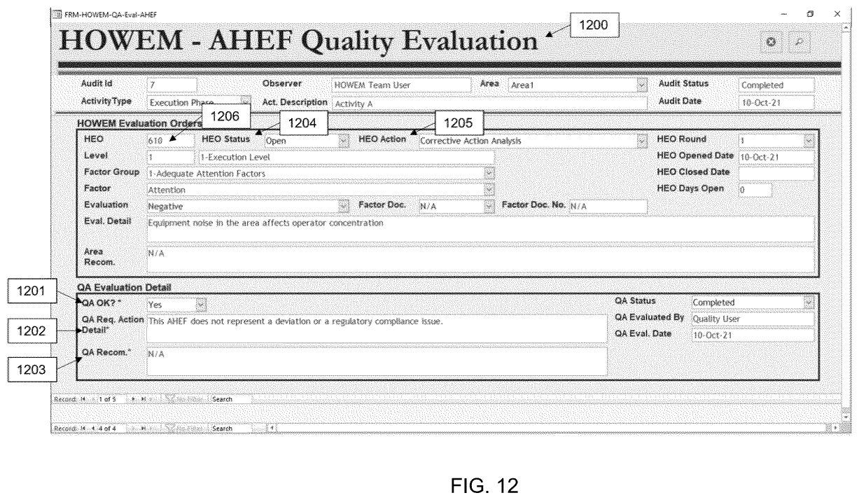

Referring to FIG. 12., Audit Evaluation 1200 will push the QA unit to evaluate all negative organizational factors 1107 identified during the Audit Execution process 1107. Quality will evaluate that those negative Factors 1107 do not represent a process deviation. The QA Ok? field 1201 is used to document the Factor evaluation by a Quality user. If Quality user determines that the identified DHEF/AHEF factor does not represent a deviation, QA OK? field should be evaluated as “Yes”. The system updates the HEO Action 1205 to Corrective Action Analysis, which means the HEO 1206 is ready for the next step of the process workflow. If Quality unit determines that the negative factor represents deviation, QA OK? field should be evaluated as “No”. Then, the system automatically updates the HEO Status 1204 field to “Cancelled” and the HEO Action 1205 to Corrective Action. Following that, the QA unit should update QA Req. Action Detail 1202 and QA Recom. 1203 fields as required.

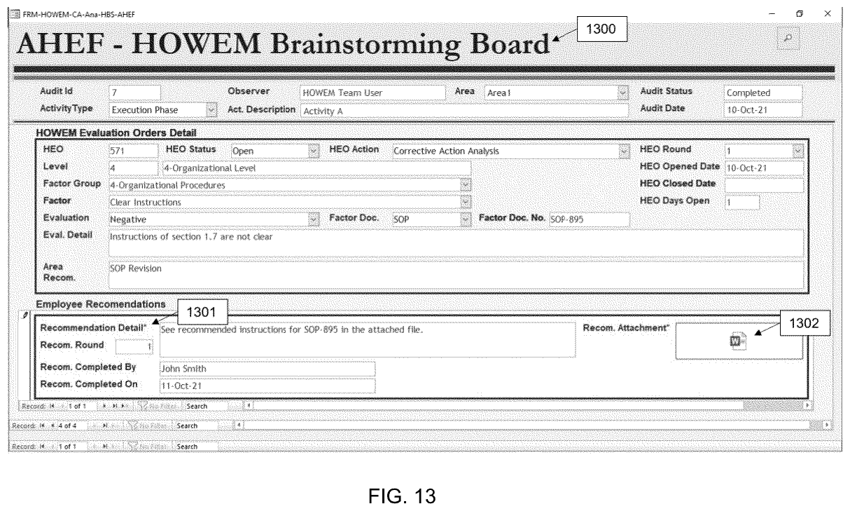

Referring to FIG. 13., once the Audit evaluation 1200 is completed, any organization employee can analyze each negative Factor 1107 using an electronic brainstorming board form 1300. First, the auditor of the area will discuss the audit results with peers to start the analysis process. In addition, the HOWEM auditor will discuss the Factors associated with any regulatory requirement to create awareness of them. During the analysis process 1300, the employees may participate in the corrective action solution process, adding corrective action recommendations 1301 to solve each negative factor 1107 identified during the audit execution process 1100. In addition, the employee can add attachments 1302 to support its recommendation.

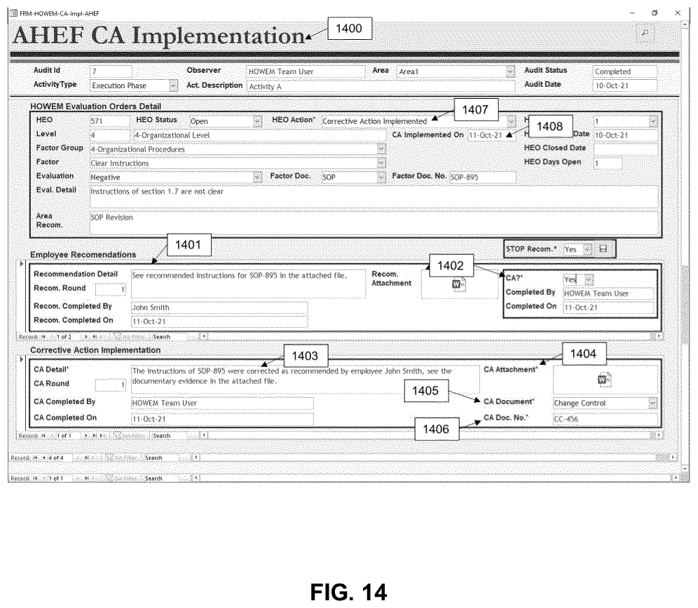

Considering FIG. 14., after completing the HOWEM Analysis process 1300, employee recommendations 1401/1301 are evaluated to implement Corrective Action as part of the CA Implementation 1400 routine. Once the Corrective Action is implemented, all employee recommendations 1401 included in the corrective action implemented are identified in the system. If the employee recommendation was implemented, CA? 1402 field should be evaluated as “Yes”, otherwise, it should be evaluated as “No”. After that a description of the implemented Corrective action is documented using in the CA Effe. Detail 1403 field. The computerized system provides the option to include document attachments 1404 and any supported CA Document 1405 including the CA Document Number 1406 used in the Corrective Action Implementation, when applicable. Once finished the documentation of all the required information above, HEO Action 1407 should be updated to “Corrective Action Implemented” and the system updates the implementation date 1408 automatically.

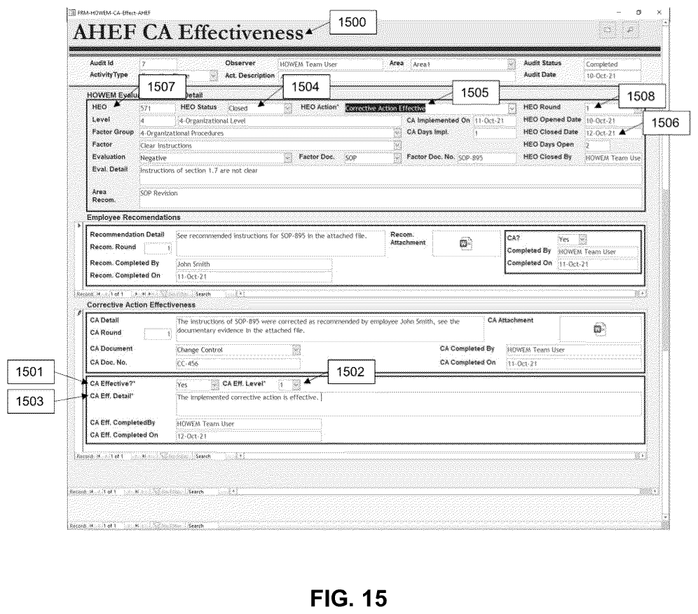

Referencing FIG. 15., after the DHEF/AHEF CA Implementation 1400, the HOWEM Team will evaluate the effectiveness of the implemented corrective action 1403. In block 1500 the computerized system will include all the related fields and details of the corrective action effectiveness. When determined that the implemented corrective action (s) are effective 1501, the CA Effective? field should be evaluated as “Yes”, the HEO Status 1504 is closed and the system updates the HEO Close date field 1506 automatically. The user should select the CA effectivity level 1502 and document the CA Effectivity Detail 1503. Otherwise, if the corrective action is not effective or if additional corrective actions are required to solve the negative factor, the HOWEM Team should return the HEO order 1507 for a new Corrective Action Analysis 1300. Following, the HEO Evaluation Round 1508 increases by one automatically once the HEO 1507 is sent back for additional analysis, then a new CA Analysis process 1300 is initiated to solve the negative factor; this process is continuous until the negative factor is corrected.

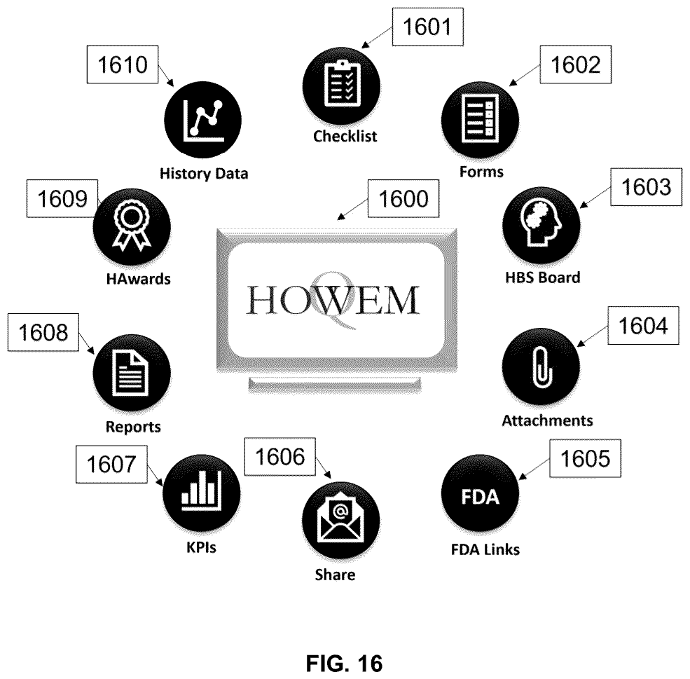

FIG. 16 describes all of the different functionalities that the system and method provide the user in the computerized system. Some of the functionalities are:

Customized HOWEM-CF Checklist 1601 to identify all the required positive Factors necessary to optimize people's work execution process. Allows forms 1602 to document all HOWEM process workflows. Includes a HBS Board function 1603 to promote employee participation by adding corrective action recommendations during the CA Analysis process. Authorizes attachment functions 1504 to add any document in the Corrective Action forms. Includes informational links 1605 to create awareness via automatic reports 1608 about the regulatory requirements associated with each negative factor 306 documented during the HOWEM audit execution 1100 process. Grants users the option to Share Functions 1606 to promote knowledge transfer in the organization via automatic reports 1608, which describe the effective corrective actions implemented. Provides visibility of Real-time KPIs 1607 and Reports 1608 to analyze DHEF/AHEF Factors data results, trends, corrective actions status, and progress. Generates HAwards Certificates 1609 (HOWEM Awards Certificates) to recognize the best recommended and effectively implemented employee corrective recommendations. Documents and archives all History data 1610 to promote the learning process focusing on the effectively implemented corrective actions that solved the identified.

What is claimed is:

1. A computerized information storage system comprising of:
a plurality of set of information located in a distinct physical site, comprising of a developed system object in a program that, when executed by the program, compose the system object to execute the following functionalities:
a. set of factors, to be evaluated as positive or negative considering impact on operational or regulatory standards,
b. an order associated to each evaluated factor to manage the identification, analysis and correction process of the potential human error causal factors,
c. attachment functions to add any documents to the forms,
d. share functions to promote knowledge amongst the different users, areas and company sites with the function to generate automatic reports,
e. set of KPIs and Metrics with the function to be generated for real-time visibility to analyze data results, trends, action status and progress,
f. generation of object certificates to recognize the best recommended and effectively implemented actions by factor,
g. storing all the unique historical data in the object database to promote the analysis and promotion of learning outcomes,
h. links to associate factors with regulatory requirements or any other organization requirement to be enforced during the Analysis and corrective action process.

2. The information storage system of claim 1, wherein the information can be stored in a cloud-based system whereas the delivery and storage of information can be either private or public via the internet.

3. The information storage system of claim 1, wherein the information will be comprised of the factors obtained through the audit process, activity and types of it analyzed and the human error causal factors in the operational areas.

4. A method comprising of:
a. receiving, by people a set of information, an observation or event related to a step in an operational process, where said information consists of positive or negative factors,
b. wherein a negative factor can increase probability of human errors in operation, determining a cause for process deviations,
c. wherein, positive factors can increase probability of human optimal work execution,
d. designating negative or positive results in product quality, people safety and customer services.

5. The method of claim 4, further comprising organizational factors with at least a unique set of organizational factors to comply with.

6. The method of claim 4, wherein it is centered in prevention comprising of a list of defined factors to be audited.

7. The method of claim 6, thereupon the auditor would at least periodically perform a random audit on his working area, including peer's performance.

8. The method of claim 6, consequently the audit process is anonymous.

9. The method of claim 6, a data structure organized by levels and factors groups, used to define the set of factors list to be audited in the process.

10. The method of claim 6, each factor will be evaluated in the audit process as positive or negative factors to promote a corrective action towards those negative factors.

11. The method of claim 6, where the aggregated positive factors will result in quality measurable results where a corrective action is not required.

12. The method of claim 6, where the aggregated negative factors can cause human error process deviations.

13. The Human Optimal Work Execution Management process is initiated through the generation of an audit record in the system.

14. The action of claim 13, where the person begins to execute the following process/steps:
a. Fill the audit record from the identification of Design Human Error Factors (DHEF), or Active Human Error Factors (AHEF),
b. Analysis evaluation order to exclude documenting deviations in the system
c. Define the corrective actions to implement to the process,
d. Deploy the implementation of the corrective actions,
e. Measure the effectiveness of the corrective actions,
f. Store the unique results in the object database,
g. Retrieve the unique process results from the object database,
h. Wherein the unique results will be available in the object database to be segmented and viewed with respect to observer, activity type, act description, audit date, audit status and area.

15. The method of claim 14, wherein the wherein the recorded DHEF/AHEF factors will result in the implemented corrective actions,
The method of claim 15, wherein the development of corrective actions is observed throughout to measure the efficiency level of its implementation.
